(19) United States
(12) Patent Application Publication
(10) Pub. No.: US 2023/0314140 A1
(43) Pub. Date: Oct. 5, 2023

(54) SYSTEMS AND METHODS FOR SAGNAC INTERFEROMETRY

(71) Applicant: AUSTRALIAN NATIONAL UNIVERSITY, Acton (AU)

(72) Inventors: Chathura Priyankara Bandutunga, Acton (AU); Acton Chak Tin Wong, Acton (AU); Jong Hann Chow, Acton (AU); Malcolm Hann Chow, Acton (AU)

(21) Appl. No.: 18/023,884

(22) PCT Filed: Aug. 19, 2021
(86) PCT No.: PCT/AU2021/050918

§ 371 Date: Feb. 28, 2023

(30) Foreign Application Priority Data
Aug. 28, 2020 (AU) 2020903073

(51) Int. Cl. G01C 19/72; G01C 25/00; H04B 10/548

(52) U.S. Cl. CPC G01C 19/722; G01C 25/00; H04B 10/548

(57) ABSTRACT

A system for fibre-optic Sagnac interferometry, the system comprising: an optical source; an optical splitter configured to split light from the optical source into a first optical beam and a second optical beam; an optical circuit comprising a first modulation unit, a second modulation unit, and an optical fibre operatively coupled between the first and second modulation units, wherein the optical circuit is operatively coupled to the optical splitter such that the first and second optical beams traverse the optical circuit in opposite directions, the first optical beam being modulated by the first modulation unit before being modulated by the second modulation unit, and the second optical beam being modulated by the second modulation unit before being modulated by the first modulation unit, wherein the first modulation unit is configured to modulate light passing through it with a first modulation code, and the second modulation unit is configured to modulate light passing through it with a second modulation code which is different from the first modulation code; an optical detector configured to detect the first and second optical beams after the first and second optical beams have traversed the optical circuit; and a processing system configured to receive from the optical detector an interference signal, which is indicative of an optical phase difference between the first and second optical beams, and to determine the optical phase difference by demodulating the interference signal based on the first and second modulation codes; wherein a correlation of the first modulation code with a time-shifted version of itself is maximum for a zero time shift; and wherein a correlation of the second modulation code with a time-shifted version of itself is maximum for a zero time shift.

### RELATED APPLICATION

This complete application is related to Australian Provisional Patent Application No. 2020903073, the originally filed specification of which is hereby incorporated herein by reference in its entirety.

### TECHNICAL FIELD

The present disclosure relates to systems and methods for Sagnac interferometry, including for sensing rotation.

### BACKGROUND

A Sagnac interferometer measures the interference between two optical beams after they have propagated in opposite directions through the same optical medium. When the interferometer is rotated with respect to a nonrotating frame, the relative phase of the two beams changes, causing a change in their interference.

Fibre-optic Sagnac interferometers can be used for rotation sensing in gyroscopes and inertial measurement systems, serving a critical function in applications requiring self-navigation and positional awareness. Such applications include aircraft navigation and avionics, space technologies, robotics, and autonomous vehicles.

The sensitivity of Sagnac fibre interferometers is primarily limited by Rayleigh scattering, caused by non-homogeneous structural variations at the molecular level within optical fibres. The interaction of optical beams with these small defects in the fibre results in small amounts of light being isotropically scattered. A fraction of the scattered light is guided along the optical fibre and detected. The scattered light can be divided into two distinct categories: coherent and incoherent. Coherent backscattering due to Rayleigh scattering is the dominant contributor to phase noise in a Sagnac interferometer. It occurs when the scattering path length is within the coherence length of the optical beam.

A way to reduce coherent Rayleigh backscatter in a Sagnac interferometer is to use a light source with low coherence, such as a superluminescent diode or LED. Nevertheless, the residual contribution of Rayleigh backscattered phase noise still presents a technical limit to the sensitivity of the interferometer.

It is desired to address or ameliorate one or more disadvantages or limitations associated with the prior art, or to at least provide a useful alternative.

### BRIEF DESCRIPTION OF THE DRAWINGS

Preferred embodiments of the present invention are hereinafter described, by way of non-limiting example only, with reference to the accompanying drawings, in which:

FIG. 1 is an example system for fibre-optic Sagnac interferometry;

FIG. 2 is plot of a signal-to-noise ratio in the measurement of an optical phase difference in an example system for fibre-optic Sagnac interferometry versus a chip frequency of a modulation code used to modulate first and second optical beams counter-propagating in a Sagnac loop of the system;

FIG. 3 is another example system for fibre-optic Sagnac interferometry including a frequency-modulated optical source;

FIG. 4 is another example system for fibre-optic Sagnac interferometry including a calibration interferometer;

FIG. 5 is another example system for fibre-optic Sagnac interferometry including multiple modulation units connected in parallel;

FIG. 6 is an example method for fibre-optic Sagnac interferometry;

FIG. 7 is an example phase constellation for QPSK modulation;

FIG. 8 is a schematic of the combination of two example binary codes into a four-level QPSK code;

FIG. 9 is a schematic of an example classification of the outputs resulting from the demodulation of a signal by a demodulation code;

FIG. 10 is a schematic of an example architecture for performing double demodulation of a signal using differentially-delayed demodulation codes;

FIG. 11 is an example phase constellation for two consecutive QPSK modulations performed by two symmetric modulators; and

FIG. 12 is an example phase constellation for two consecutive QPSK modulations performed by two anti-symmetric modulators.

### DETAILED DESCRIPTION

### First-Order Backscatter Reduction

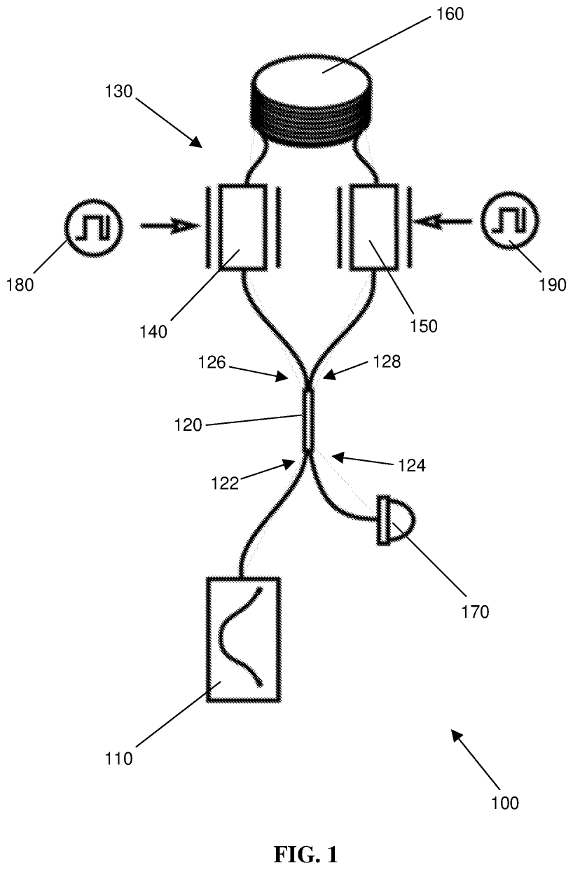

FIG. 1 illustrates an example system 100 for fibre-optic Sagnac interferometry. System 100 comprises an optical source 110 and an optical splitter 120 configured to split light from the optical source 110 into a first optical beam and a second optical beam.

System 100 further comprises an optical circuit 130. The optical circuit 130 comprises a first modulation unit 140, a second modulation unit 150, and an optical fibre 160 operatively coupled between the first modulation unit 140 and the second modulation unit 150. The optical circuit 130 is operatively coupled to the optical splitter 120 such that the first and second optical beams traverse the optical circuit 130 in opposite directions.

The first optical beam enters the optical circuit 130 through the first modulation unit 140 and exits it through the second modulation unit 150. In this way, the first optical beam is modulated firstly by the first modulation unit 140 (before entering the optical fibre 160) and secondly by the second modulation unit 150 (after exiting the optical fibre 160). Conversely, the second optical beam enters the optical circuit 130 through the second modulation unit 150 and exits it through the first modulation unit 140, so that the second optical beam is modulated firstly by the second modulation unit 150 (before entering the optical fibre 160) and secondly by the first modulation unit 140 (after exiting the optical fibre 160).

The first modulation unit 140 is configured to modulate light (e.g. the first or second optical beam) passing through it with a first modulation code generated by first signal generator 180, while the second modulation unit 150 is configured to modulate light (e.g. the first or second optical beam) passing through it with a second modulation code generated by second signal generator 190. The second modulation code is different from the first modulation code. The first signal generator 180 is configured to generate the first modulation code, and the second signal generated 190 is configured to generate the second modulation code, as described hereafter.

System 100 further comprises an optical detector 170 (e.g. a first optical detector) configured to detect the first and second optical beams after the first and second beams have traversed and exited the optical circuit 130.

System 100 further comprises a processing system (not shown) configured to receive an interference signal from the optical detector 170. The interference signal may comprise a superposition or combination of the first and second optical beams, and is therefore indicative or representative of an optical phase difference between the first and second optical beams. The processing system is further configured to determine the optical phase difference between the first and second optical beams by demodulating the interference signal based on the first and second modulation codes.

A correlation of the first modulation code with a time-shifted version of itself (i.e. an autocorrelation) is maximum for a zero time shift, such that that the first modulation code is substantially uncorrelated or, in some examples, orthogonally correlated with a non-zero time-shifted version of itself. Likewise, a correlation of the second modulation code with a time-shifted version of itself is maximum for a zero time shift, such that the second modulation code is substantially uncorrelated or, in some examples, orthogonally correlated with a non-zero time-shifted version of itself. For example, the autocorrelation of the first modulation code or of the second modulation code may be a Kronecker delta function or any other function with a single peak or with a single global maximum. The term “substantially uncorrelated” refers to the cross-correlation of the first modulation code and the second modulation code being substantially less than the autocorrelation of the first modulation code and/or the autocorrelation of the second modulation code, relative to noise in the detected the interference signal, so that the autocorrelations can be distinguished from the cross-correlation using the demodulation process disclosed herein (which includes decoding).

The configuration of system 100 is such that first-order Rayleigh scattering generated within optical circuit 130 is encoded with a code combination substantially uncorrelated and, in some examples, orthogonal to the encoding of the first and second beams. Thus, first-order Rayleigh scattering may be made incoherent with the measured first and second optical beams. Incoherent Rayleigh scattering may have a significantly lower impact on the phase sensitivity than coherent Rayleigh scattering.

In this way, the system 100 can suppress or reduce first-order coherent Rayleigh backscattering noise arising in the optical fibre 160 (i.e. the Sagnac loop). The improvement in phase sensitivity afforded by the elimination or reduction of first-order Rayleigh backscatter can be used to reduce the length of the optical fibre 160 while still improving rotational sensitivity. The shorter optical path length may in turn reduce the impact of the Shupe effect (in which thermal fluctuations along the optical path impair the symmetry between the counter-propagating first and second optical beams), in addition to reducing the weight and cost of the fibre optical fibre used in the optical circuit 130.

A phase-sensitivity improvement of, for example, two orders of magnitude may enable the optical path length in the optical circuit 130 to be reduced, yielding improvements in both signal-to-noise ratio and Shupe effect performance. In addition, the shorter path length reduces optical attenuation of the Sagnac loop, thereby reducing shot noise to a level, in some examples, well below other fundamental noise sources such as second-order Rayleigh backscatter.

The optical source 110 may be a laser or a broadband optical source, such as a white light source, a light-emitting diode (LED), or a superluminescent diode (SLD). In some examples, the first and second optical beams are modulated with a modulation bandwidth that is smaller than the linewidth of the optical source 110. A temporal resolution of the interference signal may be determined by the optical wavelength of the optical source 110.

The system 100 may further comprise an optical combiner operatively coupled to the optical circuit 130 and configured to combine the first and second optical beams after the first and second optical beams have traversed the optical circuit 130. The optical splitter 120 may be configured to perform both optical splitting and optical recombination functions (based on the direction of travel of light).

The optical splitter 120 may be an optical coupler comprising three or more ports. In the example illustrated, the optical splitter 120 is an optical coupler comprising four ports: a first port 122 is operatively coupled to the optical source 110, a second port 124 is operatively coupled to the optical detector 170, a third port 126 is operatively coupled to the first modulation unit 140, and a fourth port 128 is operatively coupled to the second modulation unit 150. The optical splitter 120 may be configured such that light entering the optical splitter 120 through the first port 122 or the second port 124 exits the optical splitter 120 through both the third port 126 and the fourth port 128, while light entering the optical splitter 120 through the third port 126 or the fourth port 128 exits the optical splitter 120 through at least the second port 124 or, in some examples, through both the first port 122 and the second port 124. Therefore, light from the optical source 110 entering the optical splitter 120 through the first port 122 is split into a first optical beam, outputted through the third port 126, and a second optical beam, outputted through the fourth port 128. Moreover, the first and second optical beams entering the fourth port 128 and the third port 126, respectively, after exiting the optical circuit 130, are outputted from the second port 124, thus being routed to the optical detector 170.

In other examples, the optical detector 170 is operatively coupled to the same port of the optical splitter 120 through which light from the optical source 110 enters the optical splitter 120 (e.g. first port 122). An optical circulator may be used to direct light from the optical source 110 to the optical splitter 120 (e.g. to first port 122) and then to direct light from the optical splitter (e.g. from first port 122) to the optical detector 170. Therefore, in some examples, the optical source 110 and the optical detector 170 are operatively coupled to the same port of the optical splitter 120, for example, through an optical circulator or through a combination of another optical coupler and an optical isolator. In other examples, the system 100 comprises multiple optical detectors, such as a first optical detector operatively coupled to first port 122 and a second detector operatively coupled to the second port 124. Therefore, the combination of the first and second optical beams after having traversed the optical circuit 130 may be detected from the first port 122 or from the second port 124 or from both the first port 122 and the second port 124.

Each of the first modulation unit 140 and the second modulation unit 150 may include one or more optical modulators, such as electro-optic modulators (EOMs) or acousto-optic modulators (AOMs). Each of the first modulation unit 140 and the second modulation unit 150 may be configured to modulate the phase of light passing through it (e.g. the first or second optical beam), for example, by performing quadrature phase-shift keying (QPSK) modulation.

In some examples, system 100 may further comprise a rotation sensor, such as a gyroscope or inertial measurement system. In other examples, system 100 forms part of a rotation sensor system. The rotation sensor may be configured to allow the optical circuit 130 to rotate (in addition to any other component of system 100). In some examples, in order to facilitate rotation sensing, the optical circuit 130 (in addition to any other component of system 100) is fixed to a platform, planar surface, or gimbal configured to rotate about an axis, such as an axis orthogonal to a plane of the optical circuit 130. The rotation sensor may sense a rotational movement (e.g. rotational speed and direction) of the optical circuit 130 based on the optical phase difference between the first and second optical beams. Therefore, in some examples, the processing system is further configured to determine a rotational movement of the optical circuit 130 based on the optical phase difference.

The optical fibre 160 comprises a first end operatively coupled to the first modulation unit 140 and a second end operatively coupled to the second modulation unit 160. The optical fibre 160 may be looped into a coil, so that optical fibre 160 is a fibre-optic coil. In some examples, an optical medium is operatively coupled between the first modulation unit 140 and the second modulation unit 150 so that the first optical beam propagates from the first modulation unit 140 to the second modulation unit through the optical medium, and the second optical beam propagates from the second modulation unit 150 to the first modulation unit 140 through the optical medium. The optical medium may comprise an optical fibre (e.g. optical fibre 160) as well as any other optical component (e.g. polarisation controllers, optical couplers).

The length of the optical circuit 130, which may be substantially defined by the length of the optical fibre 160, determines the propagation time of the first and second optical beams, which in turn affects the sensitivity the system 100 to rotation. The length of the optical fibre 160 may therefore be set or adjusted in order to vary the sensitivity of the system. In some examples, a length of the optical fibre 160 is between 100 m and 10 km.

Due to the autocorrelation properties of the first and second modulation codes, and due to the first modulation code being different from the second modulation code, the first modulation code is substantially uncorrelated or, in some examples, correlationally orthogonal to the second modulation code.

The first and second modulation codes may be pseudo-random noise codes or other types of codes having similar correlation and orthogonality properties to pseudo-random noise codes. In some examples, the first and second modulation codes are maximum length sequences (MLS), also known as “m-sequences” or “n-sequences”. Each of the first and second modulation codes may comprise a sequence of symbols, also referred to code elements or chips. Each symbol is one of a finite set of symbols (e.g. high and low, or “1”s and “0”s). In some examples, each of the first and second modulation codes is a four-level pseudo-random noise code, in which each code symbol may take on any one of four states. In other examples, each of the first and second modulations codes is a pseudo-random noise code with four or more levels, such as an eight-level code.

The first and second modulation codes may be digital or discrete-time signals. A code frequency of the first and second modulation codes may be between 1 Hz and 1 GHz, while a chip frequency (also known as “modulation rate” or “digital modulation rate”) of the first and second modulation codes may be between 1 kHz and 1 THz. The chip frequencies of the first and second modulation codes may be mutually the same, i.e. equal. A temporal resolution of the first and second modulation codes may be used to impose or modify correlation conditions and may be determined by the chip frequency.

The chip frequency of the first and second modulation codes may be controlled in order to reduce or suppress an effect of additive noise, such as relative intensity noise (RIN) from the optical source 110, on the measurement of the optical phase difference. In some examples, the chip frequency of the first and second modulation codes is equal to or greater than a bandwidth of relative intensity noise of the optical source 110.

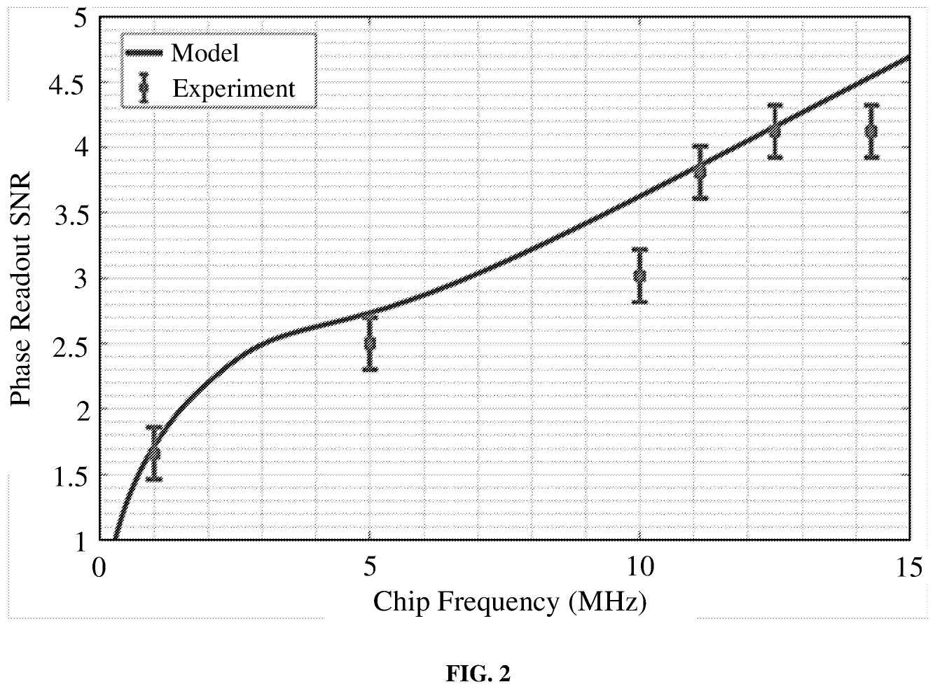

Referring to FIG. 2, there is illustrated an example plot of a signal-to-noise ratio (SNR) of the measurement of the optical phase difference versus the chip frequency of the modulation code. The plot includes a predicted curve obtained from a model of a system for fibre-optic Sagnac interferometry similar to system 100, but without the second modulation unit 150. The plot also includes data points measured in an experimental setup of the system. In the experimental setup, the optical source was a superluminescent diode whose RIN characteristics were shaped by applying band-limited white intensity noise modulation up to a bandwidth of 6.56 MHz, with an inverse frequency (i.e. 1/f) roll beyond the corner frequency. The intensity noise spectrum was generated using a 64-bit white noise generator, and shaped using a second-order cascaded-integrator-comb filter with a fixed decimation. The model curve in FIG. 2 exhibits two regimes in the evolution of phase SNR with increasing chip frequency: there is rapid gain in SNR for chip frequencies up to the RIN bandwidth (6.56 MHz), after which the SNR increases more slowly and more linearly.

Referring again to FIG. 1, the second modulation code (which is different from the first modulation code) may be a time-shifted version of the first modulation code. Therefore, in some examples, the first and second modulation codes are generated by the same signal generator, and a delay element is used to delay the first or second modulation code relative to the other. A length or duration of the time shift may be such that the first modulation code is substantially uncorrelated or correlationally orthogonal to the second modulation code. In some examples, the duration of the time shift is equal to or greater than a duration or period of a symbol of the first modulation code. In some examples, the duration of the time shift is greater than a coherence time of the optical source 110. In some examples, the duration of the time shift is greater than an amount of time required for light to propagate between the first modulation unit 140 and the second modulation unit 150.

The substantial lack of correlation and, in some examples, orthogonality between differentially-delayed first and second modulation codes provides a unique code combination, dependent on the time delay. The selected differential time delay allows the interference between the first and second optical beams at the detector 170 to be determined by cascading decoding operations with code-matching delays. The interference between the first and second optical beams at the detector 170 may be recovered with an appropriately delay-matched set of cascaded decoding operations. The determined interference between the first and second optical beams, represented by an interference signal, can be used to detect a rotational movement of the optical circuit 130.

Moreover, first-order coherent Rayleigh backscatter can be rendered incoherent, for example, by selecting a relative code delay between the first and second modulation codes such that the delay is greater than the coherence length of the optical source 110. Alternatively, if the optical source is highly coherent, first-order coherent Rayleigh backscatter can be rendered incoherent by selecting the differential time delay (also referred to as the “relative code delay” or “duration of the time-shift in the second modulation code”) to be greater than the Sagnac coil optical delay, i.e., the selected differential time delay may be greater than an amount of time required for light to propagate between the first modulation unit 140 and the second modulation unit 150 (i.e. the time required for light to propagate through the optical fibre 160 as well as any other component connected between the first modulation unit 140 and the second modulation unit 150).

In other examples, the second modulation code is an inverted version of the first modulation code, that is, the relationship between the first modulation code M₁ and the second modulation code M₂ is M₁. M₁=−M₂ so that the first and second modulation codes are anti-correlated. Therefore, in some examples, the first and second modulation codes are generated by the same signal generator, and an inverter is used to invert the first or second modulation code. In other examples, the first modulation unit 140 and the second modulation unit 150 comprise antisymmetric modulators, such that the first modulation unit 140 and the second modulation unit 150 are configured to modulate light passing through them in an inverse or anti-symmetric relation to each other. In such an arrangement, the inversion of the second modulation code relative to the first modulation code would be carried out by the internal configuration of the first modulation unit 140 and the second modulation unit 150. In an implementation, the first modulation unit 140 and the second modulation unit 150 may be provided in a single integrated device with an integrated inverter so the single integrated device requires only the first modulation code as an input and the second modulation code, in the form the inverted first modulation code, is formed within the single integrated device by the integrated inverter.

Following detection by the optical detector 170, the interference signal may be digitised. The encoding on the first and second optical beams may then be recovered via correlation against delay-matched digital demodulation codes. The phase information from the recovered interference signal may be transformed from rectilinear coordinates using an arctangent operation which may be computed in real-time or in post-processing. The processing system may comprise one or more field-programmable arrays (FPGAs) or other high-speed digital signal processing modules configured to perform these computations in real-time.

In some examples, the processing system determines the optical phase difference between the first and second beams by performing a cross-correlation of the interference signal with a first demodulation code to obtain a first demodulated signal, and by performing a cross-correlation of the first demodulated signal with a second demodulation code to obtain a second demodulated signal. The first demodulation code may be a linear and/or scaled combination of the first and second modulation codes time-shifted by a first time-shift duration, while the second demodulation code may be a linear and/or scaled combination of the first and second modulation codes time-shifted by a second time-shift duration. The first time-shift duration and the second time-shift duration differ by an amount of time required for light to propagate between the first modulation unit 140 and the second modulation unit 150. The processing system may then determine the optical phase difference between the first and second optical beams from the second demodulation signal.

The cross-correlation between the first demodulation code and the interference signal or between the second demodulation code and the first demodulation signal may have a correlation peak when the two codes being correlated are time-synchronised. The magnitude of the correlation peak relative to the correlation at other delays determines the effective rejection of noise from other delays. In some examples, e.g., when the first and second modulation codes are m-sequences, the contrast between the correlation peak and the correlation at other delays can be increased by increasing the code length of the first and second modulation codes.

System 100 may be referred to as a digitally-enhanced homodyne interferometry (DEHoI) system. Unlike digitally-enhanced heterodyne interferometry (DEHeI) systems, DEHoI systems do not require a frequency-shifted local oscillator to scan the phase of the signal field, making them compatible with single-frequency interferometers including Sagnac interferometers used for rotation sensing applications, of which system 100 is an example.

Moreover, by removing the need for a frequency-shifted local oscillator, DEHoI architectures normally necessitate fewer hardware components than equivalent heterodyne-based architectures, enabling, in some examples, the construction of optically simpler, more compact, and cheaper systems.

Optical detection in the DEHoI system is achieved by encoding an optical carrier, for example, with a four-level pseudo-random code which encodes the carrier phase at four discrete points in IQ (in-phase, quadrature) space, such as a QPSK code. As with DEHeI, the homodyne variant also allows for gating of signals based on code time-of-flight while retaining the full interferometric readout. This enables the same suite of improvements afforded by DEHeI, including a multiplexed readout from several in-line sensors, rejection of spurious electric fields due to scattering, and extraction of coarse-ranging information.

### Second-Order Backscatter Reduction

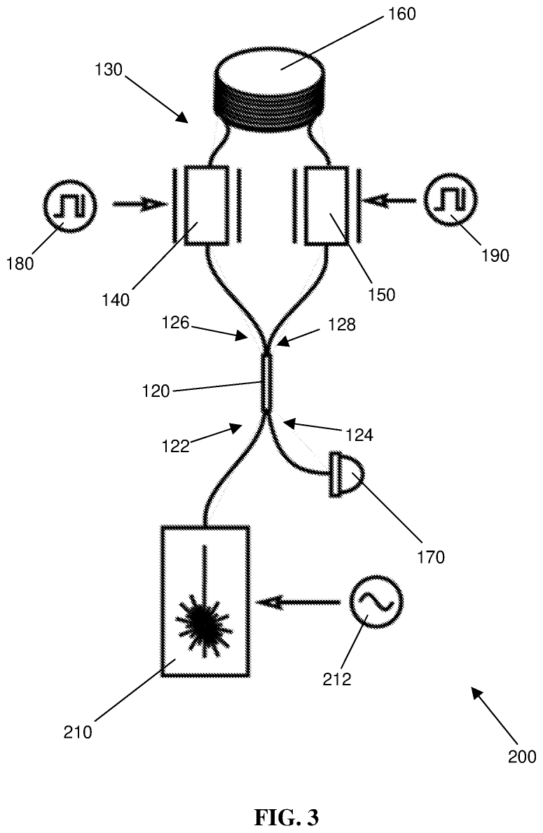

FIG. 3 illustrates another example system 200 for fibre-optic Sagnac interferometry. In addition to the elements of system 100, system 200 comprises an optical source 210 instead of source 110, which may be a laser or another narrowband optical source, and a signal generator 212 (e.g. a third signal generator). The light from the optical source 210 may be frequency-modulated by a signal generated by signal generator 212. The frequency of optical source 210 may be modulated indirectly (e.g. by an optical modulator coupled to the output of the optical source 210) or directly (e.g. by the signal generator 212 controlling operational parameters of the optical source 212).

The other components of system 200 are the same as those of system 100 described above.

Modulating the frequency of the optical source 210 may reduce or suppress second-order Rayleigh backscattered light, or double Rayleigh backscattering (DRBS). Due to the herein-described rejection of first-order Rayleigh scattering, the time-of-flight of the DRBS interference in the optical circuit 130 may be reduced to either within one code element in delay or the source coherence length, whichever is smaller, from the desired signal path. The reduced DRBS is referred to as residual DRBS.

To reject the residual DRBS, the carrier frequency (i.e. central optical frequency) of the light from the optical source 210 is modulated by detuning the optical frequency before it is split into first and second optical beams and enters the optical circuit 130. The frequency detuning of the optical source 210 causes a phase ramp of the DRBS with respect to the desired signal, upshifting DRBS out of the measurement band, allowing it to be averaged out, and suppressing or reducing its impact on the interference signal.

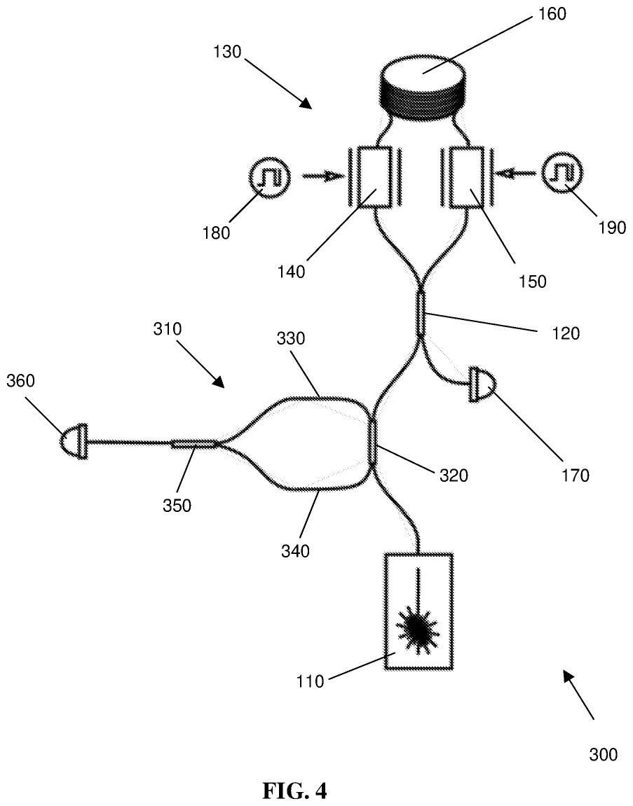

The signal generated by signal generator 212 for modulating the frequency of the optical source 210 may be a single-frequency signal or tone. In some examples, such as when the system 200 comprises a calibration interferometer such as the one described below with reference to FIG. 4, light from the optical source 210 is frequency-modulated by a frequency (f_{mod}) corresponding to the inverse of a time period (τ_{Sagnac}) required for light to propagate through the optical circuit 130 (i.e. the Sagnac coil), that is f_{mod}=1/τ_{Sagnac}. In other examples, any modulation frequency that substantially expands the spectral width and reduces coherence length of the light from the optical source may be used to modulate the frequency of the optical source 210.

### Rotation Calibration

Referring back to FIG. 1, the system 100 may further comprise a calibration interferometer configured to detect shifts or drifts in a frequency of the light of the optical source 110 relative to a frequency of light propagating in the optical circuit 130 (i.e. the frequency of the first and second optical beams). The calibration interferometer may be an arm-length difference interferometer, such as the one described below. The processing system may further be configured to determine a rotational movement of the optical circuit 130 based on the optical phase difference between the first and second optical beams and further based on the detected shifts in the frequency of the light of the optical source 110.

A “gyroscope scale factor” may be used to calibrate a relation between the optical phase difference and a rotational movement of the optical circuit 130. The gyroscope scale factor may depend on the optical path length of the optical circuit 130 and the central frequency of the optical source 110, both of which might change. By integrating the calibration interferometer, which may be a long arm-length difference interferometer, into the system 100, an independent measure of the gyroscope scale factor is obtained, allowing for compensation of drift due to changes in the central optical frequency and/or optical path length of the Sagnac coil.

FIG. 4 illustrates another example system 300 for fibre-optic Sagnac interferometry. System 300 comprises the same components of system 100 described above. System 300 further comprises a calibration interferometer 310, which may be an arm-length difference interferometer, configured to detect shifts in a frequency of the light of the optical source 110.

The calibration interferometer 310 comprises an optical coupler 320, a first optical waveguide 330, and a second optical waveguide 340, and an optical combiner 350. The optical coupler 320 comprises two input ports and two output ports. A first input port of the optical coupler 320 is operatively coupled to the optical source 110 and is configured to receive a first reference signal, which comprises a portion of the light from the optical source 110. A second input port of the optical coupler 320 is operatively coupled to the optical splitter 120 and is configured to receive a second reference signal, which comprises a portion of the first and second optical beams that have traversed the optical circuit 130. A first output port of the optical coupler 320 is operatively coupled to the first optical waveguide 330, while a second output port of the optical coupler 320 is operatively coupled to the second optical waveguide 340.

The first optical waveguide 330 and the second optical waveguide 340 are each operatively coupled, at a first end, to the optical coupler 320 such that the first optical waveguide 330 guides the first reference signal and the second optical waveguide 340 guides the second reference signal. The first optical waveguide 330 and the second optical waveguide 340 are each operatively coupled, at a second end, to the optical combiner 350, which is configured to combine the first and second reference signals.

The calibration interferometer 310 further comprises an optical detector 360 (e.g. a second optical detector, or a calibration detector) operatively coupled to the first optical waveguide 330 and to the second optical waveguide 340 through the optical combiner 350. The detector 360 is configured to detect the first and second reference signals after the first and second reference signals have traversed the first optical waveguide 330 and the second optical waveguide, respectively.

The processing system is further configured to receive from the optical detector 360 a calibration signal. The calibration signal may comprise a superposition or combination of the first and second reference signals due to interference therebetween at the optical detector 360, and is therefore indicative or representative of a frequency difference (or a phase difference due to a frequency drift) between the first and second reference signals. The processing system is further configured to determine shifts in the frequency of the light of the optical source 110 based on the calibration signal.

The calibration interferometer 310 allows for comparison of the frequencies of the first and second reference signals. Although both these signals originate from the same optical source 110, they originate at different times. They are able to reach the optical detector 360 simultaneously because they travel different distances: the first reference signal, which is the more recent of the two signals, travels from the optical source 110 to the optical detector 360 through the first optical waveguide 330; the second reference signal travels from the optical source 110 to the optical detector 360 through the optical circuit 130 and the second optical waveguide 340. The difference in the paths travelled by the first and second reference signals is the reason why the calibration interferometer 310 may be termed an arm-length difference interferometer, noting however that the “arms” of the calibration interferometer 310 are not limited to the first optical waveguide 330 and the second optical waveguide 340, but also comprise the optical circuit 130 and any other element of system 300 through which the first and second reference signals propagate in order to reach the optical detector 360. As the second reference signal travels a longer path prior to reaching the optical detector 360, it may be viewed as being delayed relative to the first reference signal. The magnitude of the delay may be, in some examples, substantially equal to the time required for light to traverse the optical circuit 130. Any shift or drift in the frequency of the optical source 110 that occurs over the time interval between the generation of the first reference signal and the second reference signal by the optical source 110 may be detected by the calibration interferometer 310.

In some examples, the first optical waveguide 330 and the second optical waveguide 340 have the same length. For example, they may both have a length of 10 cm or less. In other examples, the first optical waveguide 330 and the second optical waveguide 340 have different lengths.

The optical detector 360 therefore measures the algebraic sum of the first and second reference signals, which may be used for measuring the phase evolution between the two reference signals. The change in phase at the optical detector 360 is linearly proportional to both changes in frequency and optical path length travelled by the first and second reference signals. In some examples, due to the negligible length of the path traversed by the first reference signal compared to the path traversed by the second reference signal, differences in the optical path length are mainly due to the length of the optical circuit 130 or of the optical fibre 160. The combined effect of frequency and optical path length changes may be used to adjust the gyroscope scale factor in real-time and compensate for centre-frequency drift of the optical source 110 with respect to the Sagnac coil length.

The calibration interferometer 310 may be used to measure shifts in the frequency of the light source 110, which may be due to laser frequency noise. The coupling of a frequency shift, Δf(t), which is dependent on the length difference, ΔL(t), between the paths traversed by the first and second reference signals, may be written in terms of the scale factor interferometer phase, Δφ_{SF}, as follows:

$$Δ f ( t ) = \frac{c}{2 π n Δ L ( t )} {Δφ}_{S F} \qquad Eq . 1$$

where n is the refractive index of the optical fibre 160.

The gyroscope scale factor may be expressed as follows:

$$Ω ( t ) = \frac{λ c}{8 π AN} {Δφ}_{Sagnac} \qquad Eq . 2$$

where A is an area defines by loops or a coil of the optical fibre 160, N is the number of loops of the optical fibre 160, Ω(t) is the rotational movement (e.g. the rotation rate) of the optical circuit 130, Δφ_{Sagnac} is the measured optical phase difference between the first and second optical beams, and λ is the optical wavelength of light from the optical source 110.

When the length difference ΔL(t) between the paths traversed by the first and second reference signals is substantially equal to the length L_{coil} of the optical fibre 160, it is possible to substitute L_{coil}/2πr for the number of fibre loops, N. Equation 2 can then be rewritten as:

$$Ω ( t ) = \frac{{c}^{2}}{4 π {rfL}_{coil}} {Δφ}_{Sagnac} \qquad Eq . 3$$

The effect of optical frequency drift on the measurement of the rotational movement can be accounted for by combining Equations 1 and 3:

$${Ω}_{corrected} ( t ) = \frac{{c}^{2}}{4 π r ( f + Δ f ( t ) ) {L}_{coil}} {Δφ}_{Sagnac} \qquad Eq . 4$$

As Equation 1 is a function of dynamic changes to ΔL(t), this correction accounts not only for changes in the optical frequency of the optical source 110, but also for changes in the optical path length, including changes to the length of optical fibre 160, L_{coil}, and the refractive index, n.

Implementation-wise, this process can be performed in real-time or by storing data for post-processing correction. In the former case, the measurement of the scale factor interferometer phase Δφ_{SF} can be processed to provide a measurement of Δf(t). This is through Equation 1 using ΔL=L_{coil}. The resultant frequency shift can be added to the known central frequency, f, of the optical source 110 in accordance with Equation 4.

If post-processing is preferred, time-synchronised measurements of the scale factor phase and the Sagnac phase can be recorded and, subsequently, the rotational movement can be computed offline. In either case, the main requirement is that the two phase measurements are time-synchronised.

### Polarisation Compensation

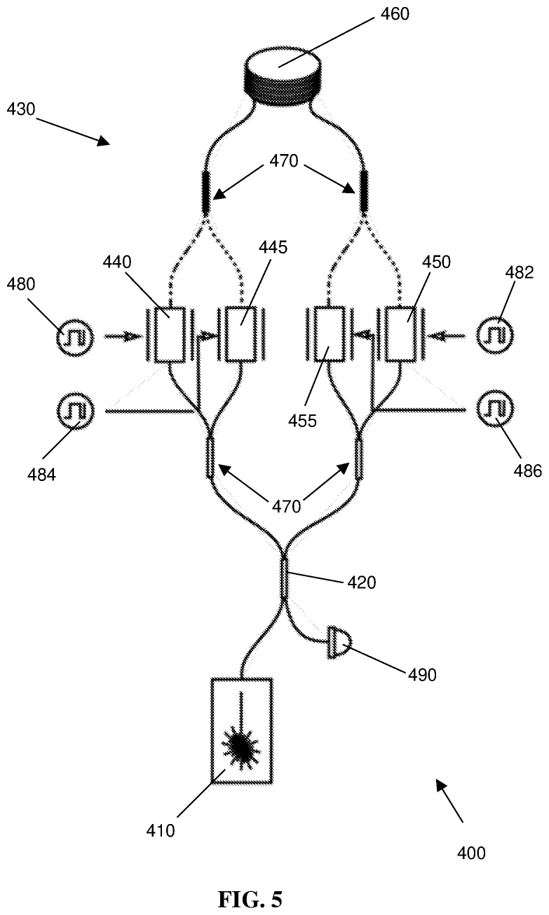

FIG. 5 illustrates another example system 400 for fibre-optic Sagnac interferometry. System 400 comprises an optical source 410 and an optical splitter 420 configured to split light from the optical source 410 into a first optical beam and a second optical beam.

System 400 further comprises an optical circuit 430 that includes a first modulation unit 440, a second modulation unit 450, a third modulation unit 445 connected in parallel to the first modulation unit 440, a fourth modulation unit connected 455 in parallel to the second modulation unit 450, and an optical fibre 460. A first end of the optical fibre 460 is operatively coupled to the first modulation unit 440 and the third modulation unit 445, while a second end of the optical fibre 460 is operatively coupled to the second modulation unit 450 and the fourth modulation unit 455. The optical circuit 430 is operatively coupled to the optical splitter 420 such that the first and second optical beams traverse the optical circuit 430 in opposite directions.

The optical circuit 430 further comprises polarisation control elements 470 configured to control a polarisation of a portion of the first and second optical beams to a first polarisation state and to control a polarisation of another portion of the first and second beams to a second polarisation state. In this way, the first optical beam traverses the optical circuit 430 in two polarisation states (i.e. the first and second polarisation states), and, likewise, the second optical beam traverses the optical circuit 430 in two polarisation states.

The portion of the first and second optical beams in the first polarisation state may comprise a fraction (e.g. half, or a third, or any other substantial fraction) of the power of first and second optical beams. The portion of the first and second optical beams in the second polarisation state would then comprise the remaining power of the first and second optical beams.

The first modulation unit 440 and the second modulation unit 450 are configured to modulate the portion of the first and second optical beams in the first polarisation state. The first modulation unit 440 is configured to modulate light passing through it with a first modulation code generated by a first signal generator 480, while the second modulation unit 450 is configured to modulate light passing through it with a second modulation code generated by a second signal generator 482.

The third modulation unit 445 and the fourth modulation unit 455 are configured to modulate the portion of the first and second beams in the second polarisation state. The third modulation unit 445 is configured to modulate light passing through it with a third modulation code generated by a third signal generator 484, while the fourth modulation unit 455 is configured to modulate light passing through it with a fourth modulation code generated by a fourth signal generator 486.

Each of the first, second, third, and fourth modulation codes may be different from each of the other modulation codes of the first, second, third, and fourth modulation codes.

System 400 further comprises an optical detector 490 configured to detect the first and second optical beams (in both polarisation states) after the first and second optical beams have traversed and exited the optical circuit 430.

System 400 further comprises a processing system (not shown) configured to receive an interference signal from the optical detector 490. The interference signal may comprise a superposition or combination of the first and second optical beams, and is therefore indicative or representative of an optical phase difference between the first and second optical beams. The processing system is further configured to determine a polarisation transfer function or characteristic of the optical circuit 430 by demodulating the interference signal based on the first, second, third, and fourth modulation codes, and to determine the optical phase difference between the first and second optical beams based on the polarisation transfer function.

As described above with reference to system 100 of FIG. 1, a correlation of the first modulation code, or of the second modulation code, or of the third modulation code, or of the fourth modulation code with a time-shifted version of itself is maximum for a zero time shift. Therefore, each modulation code is substantially uncorrelated or, in some examples, orthogonally correlated with a non-zero time-shifted version of itself.

In some examples, the first polarisation state and the second polarisation state are orthogonal to each other. In other examples, the first polarisation state and the second polarisation state are not orthogonal to each other.

The polarisation control elements 470 may comprise one or more polarisation controllers, polarisation splitters, and polarisation combiners. The polarisation control elements 470 may be operatively coupled to either the input port, the output port, or both input and output ports of the modulation units. The polarisation control elements 470 may be configured to block light in the first polarisation state from entering the third modulation unit 445 and the fourth modulation unit 455, and to block light in the second polarisation state from entering the first modulation unit 440 and the second modulation unit 450.

In some examples, the polarisation transfer function comprises a Jones matrix for the optical circuit 430. The demodulation of the interference signal based on the first, second, third, and fourth modulation codes results in four separate values or measurements which are permutations of the two polarisation states for each of the two optical beams (e.g. if the two polarisation states of the first optical beam are denoted by S1 and P1 and the two polarisation states of the second optical beam are denoted by S2 and P2, the four permutations generated through photodetection include S1S2, S1P2, P1S2, and P1P2). The processing system may then demodulate each of these measurements and compute the phase of the determinant of the Jones matrix for the optical circuit 430.

The system 400 provides a real-time measurement of the polarisation changes across the optical circuit 430. The aggregate of these polarisation changes is represented by a Jones matrix (or another polarisation transfer function) of the path of the first optical beam with respect to the path of the second optical beam. By demodulating with the four possible output code combinations, the system 400 recovers all relevant changes to the input polarisation state.

By measuring the phase of the Jones matrix determinant angle (a·d−b·c), the system 400 removes or mitigates polarisation changes from the interference signal, thus recovering the interference signal at the optical detector 490 substantially free from polarisation noise and polarisation fading. The Jones matrix determinant phase measurement is algebraically independent of any Faraday effects caused by spurious magnetic fields, which cause changes in the polarisation state of light.

The system 400 does not require the use of polarisation-maintaining optical fibre within the optical circuit 430. Even when a standard single mode fibre coil is used in the optical circuit 430, all polarisation variations or evolutions can be tracked and removed in post processing when measuring the Jones matrix determinant phase.

### Method for Fibre-Optic Sagnac Interferometry

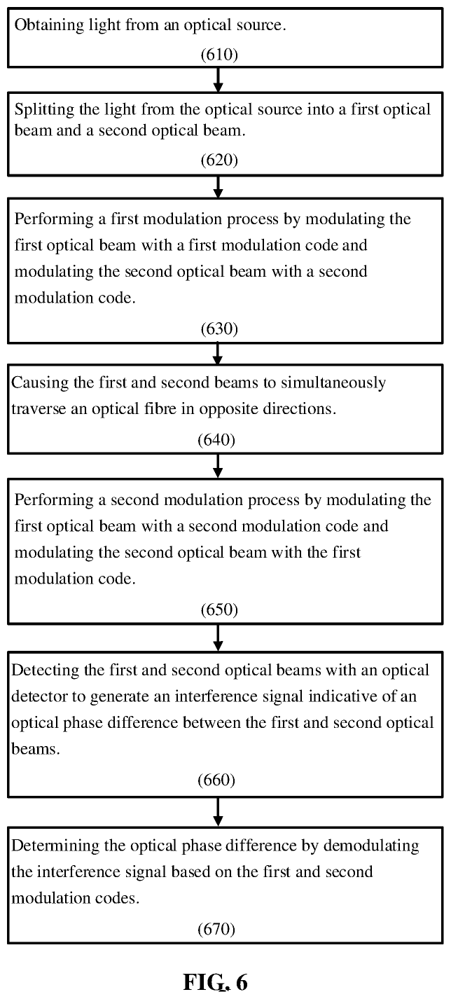

Referring to FIG. 6, there is illustrated an example method 600 for fibre-optic Sagnac interferometry. Method 600 comprises a step 610 of obtaining light from an optical source, and a step 620 of splitting the light from the optical source into a first optical beam and a second optical beam.

Method 600 further comprises a step 630 of performing a first modulation process by modulating the first optical beam with a first modulation code and modulating the second optical beam with a second modulation code. The second modulation code is different from the first modulation code.

A correlation of the first modulation code with a time-shifted version of itself is maximum for a zero time shift. A correlation of the second modulation code with a time-shifted version of itself is maximum for a zero time shift.

After step 630, method 600 comprises a step 640 of causing the first and second beams to simultaneously traverse an optical fibre in opposite directions.

After step 640, method 600 comprises a step 650 of performing a second modulation process by modulating the first optical beam with the second modulation code and modulating the second optical beam with the first modulation code.

After step 650, method 600 comprises a step 660 of detecting the first and second optical beams with an optical detector to generate an interference signal indicative of an optical phase difference between the first and second optical beams.

Method 600 further comprises a step 670 of determining the optical phase difference by demodulating the interference signal based on the first and second modulation codes. Step 670 may be performed by a processing system.

Implementation with QPSK—The interference Signal

The present and following sections explain how the system 100 illustrated in FIG. 1 may encode the first and second optical beams with orthogonal, pseudo-random QPSK codes and how decoding may be performed at the optical detector in order to measure the phase difference acquired by the first and second optical beams after traversing the optical circuit.

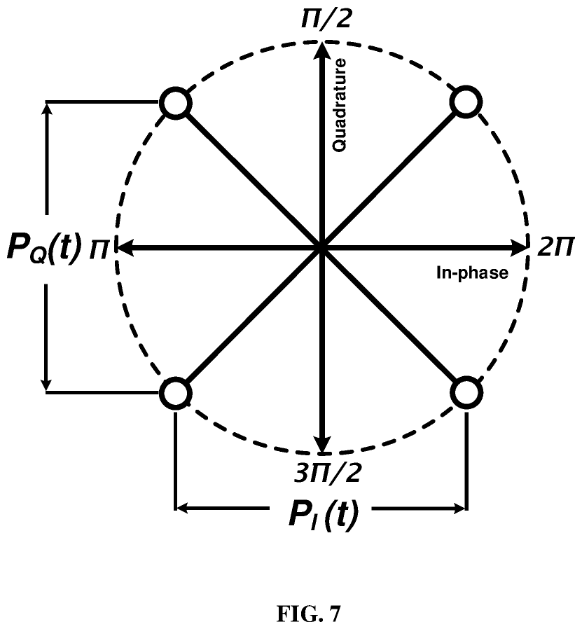

QPSK is a phase modulation technique in which the phase of an optical carrier is shifted by one of four phase values based on the state of the QPSK modulation code. The four phase values may be separated by π/2 radians. FIG. 7 shows an example phase constellation for QPSK modulation, including phase values of π/4, 3π/4, −3π/4, and −π/4.

A single pseudo-random QPSK code may be represented by two binary pseudo-random codes or sequences, P_{I}(t) and P_{Q}(t). Table 1 below presents an example mapping binary sequences P_{I}(t) and P_{Q}(t) to a QPSK phase value of the optical carrier:

TABLE 1

| P_{I}(t) | P_{Q}(t) | QPSK phase shift |
|---|---|---|
| 1 | 1 | π/4 |
| 0 | 1 | 3π/4 |
| 0 | 0 | −3π/4 |
| 1 | 0 | −π/4 |

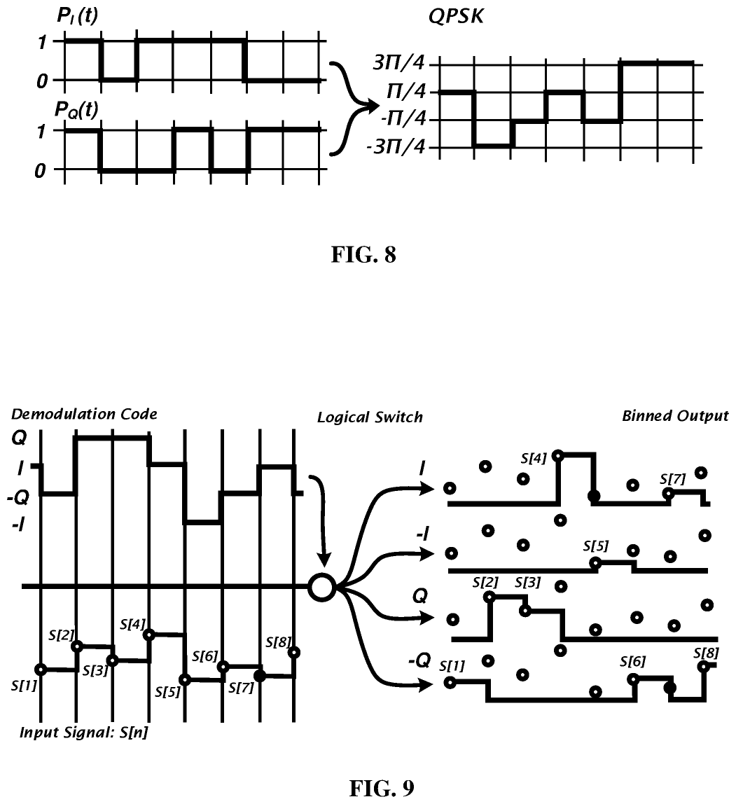

The QPSK code retains the same chip frequency and length as the two binary codes that compose it. The length of the QPSK (or binary) code is given by 2^{N}−1, where N is the number of bits. For example, FIG. 8 illustrates two example binary codes, P_{I}(t) and P_{Q}(t), each having a length of 3 bits, and a corresponding QPSK code resulting from the two binary codes. The resulting QPSK code is also 3 bits long. Moreover, a QPSK code generated by two pseudo-random binary sequences will also be pseudo-random and, like the two binary sequences, will be uncorrelated with a time-shifted version of itself.

QPSK modulation of an optical carrier may be performed with a modulator such as an electro-optic modulator or an acousto-optic modulator.

Electro-optic modulators may allow for fast modulation frequencies on the order of 100 MHz or greater. The magnitude of the phase shift is proportional to the voltage applied to the modulator, which may be calibrated to the transfer function of a particular modulator to ensure that modulation produces accurate phase shifts in the optical carrier. Electro-optic modulators may be implemented by integrated photonic devices, such as multi-function integrated optical chips.

Acousto-optic modulators are typically used to introduce frequency shifts and, nominally, the driving frequency of these modulators is kept fixed, imparting a fixed frequency shift to the optical carrier. However, by controlling the phase of the drive frequency, an exact phase shift can be applied in addition to the frequency shift.

Before considering the operation of system 100, a simplified system is considered, which is equivalent to system 100 except for the presence of the second modulation unit. That is, in the simplified system, the first and second optical beams are modulated only by the first modulation unit. The effect of the second modulator will be explained further on.

The continuous wave (CW) electric field, E(t), immediately following QPSK modulation may be represented as follows:

E(t)=\tilde{E}(t)(C_{I}(t)+iC_{Q}(t))e^{iωt+iφ(t)} Eq. 5

where C_{I}(t) and C_{Q}(t) may take on a value of 1 or −1 depending on the state of the QPSK modulation code.

In the system 100, both the first and second optical beams are modulated by the first modulation unit. However, since the two beams travel through the optical circuit in opposite directions, the time of modulation differs between the two beams. Specifically, the second optical beam is modulated just prior to exiting the optical circuit, while the first beam is modulated as soon as it enters the optical circuit and accumulates a time delay of τ_{S} as it traverses the optical circuit (i.e. the Sagnac coil). Therefore, the electric fields of the first beam E₁(t) and of the second beam E₂(t) may be expressed as follows:

E₁(t)=\tilde{E}(t)(C_{I}(t−τ_{S})+iC_{Q}(t−τ_{S}))e^{iωt+iφ(t)} Eq. 6

E₂(t)=\tilde{E}(t)(C_{I}(t)+iC_{Q}(t))e^{iωt+iφ(t)} Eq. 7

Here, the two modulation codes are delayed relative to each other by a fixed time-of-flight delay, τ_{S}, which is a function of the length of the optical fibre of the optical circuit. The corresponding code delay between the two fields results in effectively two unique QPSK codes being present at the optical detector, one for the first optical beam and one for the second optical beam.

The optical power on the optical detector, P_{D}, is given by the modulus squared of the superposition of the two fields. The first-order code terms that are used for the demodulation process, each of which represents a combination of I and Q binary codes modulated onto the signal or local oscillator field, are shown below:

P_{D}=|\tilde{E}(t)|²C_{I}(t)C_{I}(t−τ_{S})cos(Δφ(t))+|\tilde{E}(t)|²C_{I}(t)C_{Q}(t−τ_{S})sin(Δφ(t))−|\tilde{E}(t)|²C_{Q}(t)C_{I}(t−τ_{S})sin(Δφ(t))+|\tilde{E}(t)|²C_{Q}(t)C_{Q}(t−τ_{S})cos(Δφ(t)) Eq. 8

As can be seen from the above expressions, the output of the optical detector is doubly modulated. The extraction of the optical phase difference, Δφ(t), between the first and second optical beams therefore requires a two-stage, or double demodulation, process.

### Double Demodulation for Single Modulator Implementation

Following digitisation, the interference signal is decoded by correlating it against two copies of the original QPSK modulation code. The two demodulation codes are time-shifted by two unique delays, τᵢ and τⱼ. Since the QPSK code can be decomposed into two binary codes in the I and Q quadratures and since there are two demodulation delays, there are four permutations of the decoding operation as listed below:

II⇒C_{I}(t−τᵢ)C_{I}(t−τⱼ) Eq. 9

IQ⇒C_{I}(t−τᵢ)C_{Q}(t−τⱼ) Eq. 10

QI⇒C_{Q}(t−τᵢ)C_{I}(t−τⱼ) Eq. 11

QQ⇒C_{Q}(t−τᵢ)C_{Q}(t−τⱼ) Eq. 12

In the present example, τᵢ=0 and τⱼ is the coil delay, τ, or time taken for light to traverse the optical fibre of the optical circuit. From these code combinations, it is possible to infer the physical meaning of the demodulation process. Demodulation with the II and QQ codes represents the I and Q codes interfering with time-shifted versions of the same. In other words, they do not have a relative phase shift between them, and thus represent the “in-phase” component of the interference signal. The remaining two terms, IQ and QI, represent the interference of one code against another. These cross-terms interfere against each other with a π/2 relative phase shift, thus representing the “quadrature” component of the interference signal.

Applying the demodulation codes to the digitised photodetector output results in the following four auto-correlation functions representing each of the possible projections:

$$II ( t ) = {\sum }_{t = 0}^{{L}_{c o d e}} {C}_{I} ( t - {τ}_{i} ) {C}_{I} ( t - {τ}_{j} ) \times {P}_{D 1} ( t ) \qquad Eq . 13$$

$$IQ ( t ) = {\sum }_{t = 0}^{{L}_{c o d e}} {C}_{I} ( t - {τ}_{i} ) {C}_{Q} ( t - {τ}_{j} ) \times {P}_{D 1} ( t ) \qquad Eq . 14$$

$$QI ( t ) = {\sum }_{t = 0}^{{L}_{c o d e}} {C}_{Q} ( t - {τ}_{i} ) {C}_{I} ( t - {τ}_{j} ) \times {P}_{D 1} ( t ) \qquad Eq . 15$$

$$QQ ( t ) = {\sum }_{t = 0}^{{L}_{c o d e}} {C}_{Q} ( t - {τ}_{i} ) {C}_{Q} ( t - {τ}_{j} ) \times {P}_{D 1} ( t ) \qquad Eq . 16$$

where L_{code} is the code length of the QPSK code and P_{D1}(t) is the digitised interference signal outputted by the optical detector.

The following expressions for each of the four IQ projections can be obtained through the computation of the auto-correlation by integrating over the code length:

II(t)= [symbol] ᵢⱼβ cos(Δφ(t)) Eq. 17

IQ(t)= [symbol] ᵢⱼβ sin(Δφ(t)) Eq. 18

QI(t)=− [symbol] ᵢⱼβ sin(Δφ(t)) Eq. 19

QQ(t)= [symbol] ᵢⱼβ cos(Δφ(t)) Eq. 20

where [symbol] ᵢⱼ represents the auto-correlation magnitude for codes of delay τᵢ and τⱼ. The coefficient β is given by the digitised amplitude of each sample. This correlation is maximised when the two demodulation delays are equal to the delays of the two detected codes, i.e. when τᵢ=0 and τⱼ is the coil delay, τ. For other delays, the correlation characteristics of the time-delayed codes means the correlation is small, and the noise at that delay is minimised.

In order to implement this correlation process in digital signal processing, a technique named “binning” may be used. The binning method uses the pre-determined QPSK logic described in Table 1 above to correlate a received sample with a particular measurement quadrature, as shown in FIG. 9. The sample is subsequently “binned” or associated with a particular phase quadrature.

The binning architecture uses an input demodulation QPSK code to sort incoming samples into IQ projections. Following the binning process, the samples in each channel are integrated over a code length, resulting in an averaged value for each of the four projections. When the delay of the demodulation code coincides with an optical delay, the projections imparted by the modulation code are correctly identified and sorted appropriately, with the integration resulting in an average value for each quadrature. When the delay does not match a received code, the binning process does not correlate with the phase projections imparted by the received code, and the resultant output after the integration averages towards 1/L_{code}, where L_{code} is the code length, assuming that the modulation codes are m-sequences.

As shown in FIG. 9, when the demodulation code is matched to the received code, this process separates the samples correctly. When the demodulation code is out of phase with the received code, the same process is equivalent to re-encoding with another QPSK code and the demodulation process causes the incorrectly decoded signals to be spread out as broadband noise.

One way to define a demodulation code is by an integer multiple of π/4 phase shifts in the phase projection. For example, the sample pertaining to a measurement in the I quadrature corresponds to a +π/4 phase shift, which is defined as a +1 shift. The four projections used for a single modulator system are the following:

| | | | |
|---|---|---|---|
| I = 1 | Q = 3 | −I = −3 | −Q = −1 |

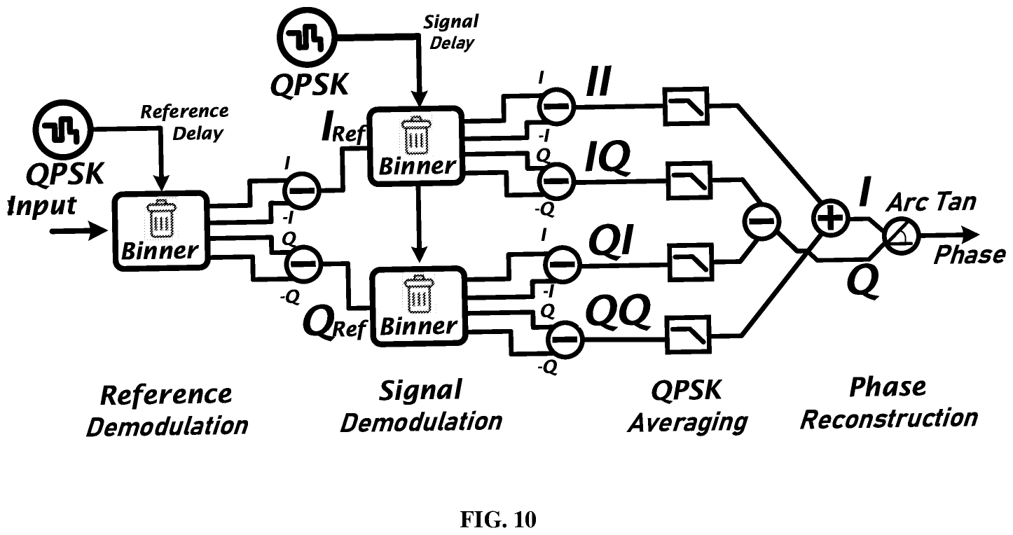

The binning operation is able to demodulate one code at a time. In order to perform the double demodulation, two of these binning operations are cascaded. The full architecture is shown in FIG. 10. The output of the first binning stage produces four terms, one for each quadrature. Subtracting the I and −I terms returns the total “in-phase” component for the first demodulation stage. The total “quadrature” component can be similarly calculated. The I/Q data streams become inputs into two parallel binning operations for the second demodulation stage. Both of the parallel second stages produce I and Q outputs, representing the four combinations of II, IQ, QI and QQ as discussed above.

The penultimate stage of the demodulation process is averaging which may be implemented by an averaging filter that integrates over the code length. Example averaging filters include, but are not limited to, decimation filters. This functions as the summation over the code length which is required to determine the correlation as described above.

The final step in the double demodulation process is the recovery of the full phase projection. The “in-phase” or I component of the phasor is represented by the II and QQ projections, while the “quadrature” or Q component represented by the remaining cross-terms, the IQ and QI projections. Computing the vector sum of these components, the following phase projection can be obtained:

s(t)=[II(t)+QQ(t)]Î+[IQ(t)−QI(t)]\hat{Q} Eq. 21

The arctangent of the quadrature and in-phase components thus yields the phase difference, Δφ(t), between the two components:

$$Δφ ( t ) = arctan ( \frac{IQ ( t ) - QI ( t )}{II ( t ) + Q Q ( t )} ) \qquad Eq . 22$$

FIG. 10 illustrates the architecture of a signal processor, which may be implemented by a correspondingly configured real-time processing module (e.g., an FPGA), for performing the double demodulation process. Following digitisation, the input is binned according to a reference delayed QPSK code, as shown in the example of FIG. 9. The first demodulation is equivalent to rotating the phasor to the frame of the reference field. The second demodulation computes the projections of the signal field with respect to the IQ projections of the reference field. The resultant four projections (II, QQ, IQ, QI) are then used to reconstruct the final IQ projection of the phase difference between the two fields, in accordance with Equation 21. The phase is then computed using Equation 22.

### Double Demodulation for Dual-Modulator Implementation

In a dual-modulator gyroscope, there are two modulation units within the Sagnac coil. As there are two optical beams (the first and second optical beams, or CW and CCW), each encoded with two codes, there are four orthogonal QPSK codes being detected and requiring decoding at the optical detector output. The two modulation codes can be made by digitally delaying one modulation code relative to the other.

Instead of developing an architecture to demodulate all four codes separately, two compound codes can be considered, one for each for the first and second beams. For two QPSK modulation codes, M_{CW}(t) and M_{CCW}(t), the compound modulation codes for the first and second optical beams can be written as:

CW_{QPSK}(t)=M_{CW}(t−τ)+M_{CCW}(t) Eq. 23

CCW_{QPSK}(t)=M_{CW}(t)+M_{CCW}(t−τ) Eq. 24

where τ is the optical delay between the first and second modulation units (i.e. the coil delay). The interferometer measures the optical phase difference between the first and second optical beams, which include contributions from each of the four modulation codes:

CW_{QPSK}(t)−CCW_{QPSK}(t)=M_{CW}(t−τ)+M_{CCW}(t)−M_{CW}(t)−M_{CCW}(t−τ) Eq. 25

In order to demodulate these compound codes, digital codes are generated (similarly to the single-modulator case described above) which can be used to subsequently “bin” samples into the desired measurement quadrature. For the binning operation to be successful, the phase shift imparted by every combination of the two modulation codes must be determined.

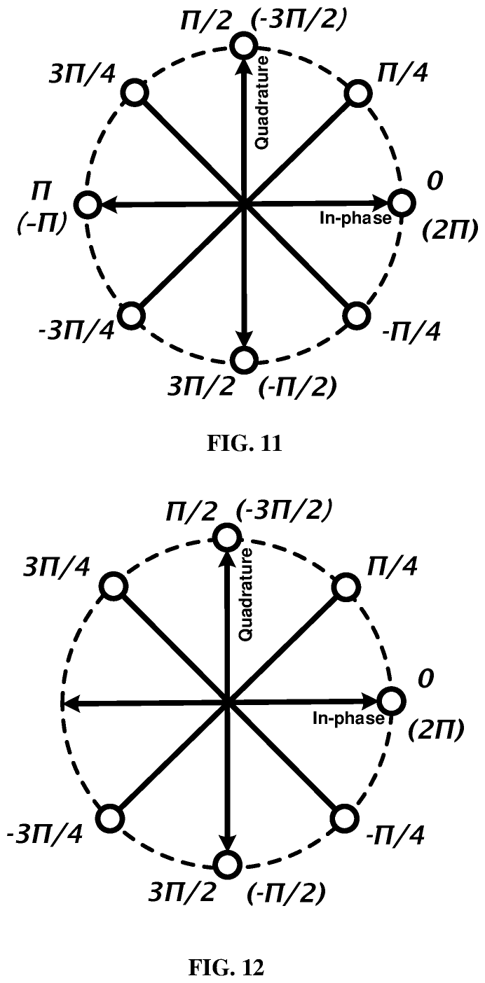

FIG. 11 illustrates the phase constellation of possible phase shifts imparted by the combination of the first and second modulation units. The first modulation unit imparts a four-point phase constellation, identical to that of FIG. 7. The second modulation unit then rotates this by an odd-integer multiple of π/4, yielding a total phase rotation which is an integer multiple of π/2. Accounting for positive and negative phase shifts, there are seven possible combinations of phase shifts. However, these combinations occur in degenerate pairs (e.g. π/2 and −3π/2 or π and −π).

If the binner logic is modified to track the total number of π/2 phase shifts generated by the double modulation process, a scaled linear combination of the generating codes M_{CW}(t) and M_{CCW}(t) can be used as the input to the logical switch. As each of these codes incur integer multiple phase shifts of π/4, the π/2 scaled compound code for demodulation can be written as follows:

$${Demod}_{1} ( t ) = \frac{2}{π} ( {M}_{C W} ( t - τ ) + {M}_{C C W} ( t ) ) \qquad Eq . 26$$

and similarly for the second demodulation code, Demod₂(t). The value of the demodulation code can then be used to define the following logic operations to demodulate all seven phase projection combinations:

| | |
|---|---|
| I = 0 | |
| Q = 1 | Q = −1 |
| −I = 2 | −I = −2 |
| −Q = 3 | −Q = −3 |

Following the above binning logic, the remainder of the demodulation architecture follows that shown in FIG. 10.

### Dual Antisymmetric Modulator Implementation

Gyroscope modulators may be embedded in photonic chips known as multi-function optical chips (MIOCs). These chips house a waveguide coupler/splitter and the two modulators, which share common electrical connections. As a result they are configured to modulate in a differential fashion, with one modulator's phase shift being the negative of the other's phase shift. This section outlines how the DEHoI constellation in the system 100 can be adapted to function in this configuration.

The CW and CCW compound modulation codes for a system having two antisymmetric modulation units in the Sagnac loop may be written as follows:

CW_{QPSK}(t)=M_{CW}(t−τ)+M_{CCW}(t)→M_{CW}(t−τ)−M_{CW}(t) Eq. 27

CCW_{QPSK}(t)=M_{CW}(t)+M_{CCW}(t−τ)→M_{CW}(t)−M_{CW}(t−τ) Eq. 28

Therefore, the modulation on the first light beam, CW_{QPSK}(t), is an inverted copy of the modulation on the second light beam CCW_{QPSK}(t); that is, CW_{QPSK}(t)=−CCW_{QPSK}(t).

As the interferometer measures the optical phase difference between the first and second beams, the phase difference caused by the QPSK modulation in this case results in π depth modulation. This can be seen by computing the QPSK phase difference between the first and second light beams:

CW_{QPSK}(t)−CCW_{QPSK}(t)=2(M_{CW}(t−τ)−M_{CW}(t)) Eq. 29

In order to compensate for the factor of 2 in Equation 29, the modulation depth must be halved from multiples of π/4 to multiples of π/8. By using a π/8 modulation depth for each modulation unit, compound codes can be constructed that result in π/4 modulation depth, and the interferometer difference will again map out all four quadratures. The phase constellation however becomes a seven-point constellation, as shown in FIG. 12. The eighth unique phase point does not exist as the maximum phase excursion is now ±3π/8±3π/8, which does not reach all the way around to π phase.

As with the dual-modulator case described hereinbefore, compound demodulation codes can be constructed for the CW_{QPSK}(t) and CCW_{QPSK}(t) modulated fields. The demodulation codes can be written in terms of a scaled, linear combination of the modulation codes. This results in demodulation codes which map the integer number of π/4 phase steps.

In order to formulate a binning architecture for this system, the basis for the demodulation is first picked. Continuing with the same basis as in the dual-modulator system previously considered, the x-axis can be considered the I quadrature, and the y-axis can be considered the Q quadrature. For the constellation points along the basis axes (0, π/2, 3π/2), these can be binned directly into their respective quadratures. Written in terms of π/4 shifts, this amounts to the following logic operations:

| | | |
|---|---|---|
| 0 = I | 2 = Q | −2 = −Q |

The off-axis constellation points can be split equally between the two contributing basis quadratures. This produces the following binning conditions for the off-axis constellation points:

$$\begin{matrix}1 = \frac{I + Q}{\sqrt{2}} & - 1 = \frac{I - Q}{\sqrt{2}} \\ 3 = \frac{Q - I}{\sqrt{2}} & - 3 = \frac{- I - Q}{\sqrt{2}}\end{matrix}$$

With a binner designed to accommodate these projections, the rest of the demodulation process follows the same process as the other described in the previous sections.

Although the decoding processes in the dual-modulator implementation and in the dual antisymmetric modulator implementation have been described as involving correlation using two compound demodulation codes, alternative mathematically equivalent compound codes may be used instead. Alternatively, additional demodulation stages may be used in place of compound codes. In some examples, any combination of the above-described operations may be used to obtain the same coding or decoding result.

### Interpretation

Many modifications will be apparent to those skilled in the art without departing from the scope of the present invention.

The presence of “/” in a FIG. or text herein is understood to mean “and/or” unless otherwise indicated. The recitation of a particular numerical value or value range herein is understood to include or be a recitation of an approximate numerical value or value range, for instance, within +/−20%, +/−15%, +/−10%, +/−5%, +/−2.5%, +/−2%, +/−1%, +/−0.5%, or +/−0%. The term “essentially all” or “substantially” can indicate a percentage greater than or equal to 90%, for instance, 92.5%, 95%, 97.5%, 99%, or 100%.

The reference in this specification to any prior publication (or information derived from it), or to any matter which is known, is not, and should not be taken as an acknowledgment or admission or any form of suggestion that prior publication (or information derived from it) or known matter forms part of the common general knowledge in the field of endeavor to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A system for fibre-optic Sagnac interferometry, the system comprising:
an optical source;
an optical splitter configured to split light from the optical source into a first optical beam and a second optical beam;
an optical circuit comprising a first modulation unit, a second modulation unit, and an optical fibre operatively coupled between the first and second modulation units, wherein the optical circuit is operatively coupled to the optical splitter such that the first and second optical beams traverse the optical circuit in opposite directions, the first optical beam being modulated by the first modulation unit before being modulated by the second modulation unit, and the second optical beam being modulated by the second modulation unit before being modulated by the first modulation unit, wherein the first modulation unit is configured to modulate light passing through it with a first modulation code, and the second modulation unit is configured to modulate light passing through it with a second modulation code which is different from the first modulation code;
an optical detector configured to detect the first and second optical beams after the first and second optical beams have traversed the optical circuit; and
a processing system configured to receive from the optical detector an interference signal, which is indicative of an optical phase difference between the first and second optical beams, and to determine the optical phase difference by demodulating the interference signal based on the first and second modulation codes;
wherein a correlation of the first modulation code with a time-shifted version of itself is maximum for a zero time shift; and
wherein a correlation of the second modulation code with a time-shifted version of itself is maximum for a zero time shift.

2. The system of claim 1, wherein the second modulation code is substantially uncorrelated from the first modulation code, and the second modulation code is a time-shifted version of the first modulation code.

3. The system of claim 2, wherein the duration of the time shift is equal to or greater than a duration of a symbol of the first modulation code.

4. The system of claim 2, wherein the duration of the time shift is greater than a coherence time of the optical source.

5. The system of claim 2, wherein the duration of the time shift is greater than an amount of time required for light to propagate between the first modulation unit and the second modulation unit.

6. The system of claim 1, wherein the second modulation code is an inverted version of the first modulation code.

7. The system of claim 1, wherein the first and second modulation codes are pseudo-random noise codes.

8. The system of claim 7, wherein the first and second modulation codes are four-level pseudo-random noise codes.

9. The system of claim 8, wherein the first and second modulation units are configured to perform quadrature phase-shift keying (QPSK) modulation on light passing through them.

10. The system of claim 1, wherein a chip frequency of the first and second modulation codes is equal to or greater than a bandwidth of relative intensity noise of the optical source.

11. The system of claim 1, wherein the processing system is configured to determine the optical phase difference by further being configured to:
perform a cross-correlation of the interference signal with a first demodulation code to obtain a first demodulated signal;
perform a cross-correlation of the first demodulated signal with a second demodulation code to obtain a second demodulated signal; and
determine the optical phase difference between the first and second beams from the second demodulation signal;
wherein the first demodulation code is a linear combination of the first and second modulation codes time-shifted by a first time-shift duration;
wherein the second demodulation code is a linear combination of the first and second modulation codes time-shifted by a second time-shift duration;
wherein the first time-shift duration and the second time-shift duration differ by an amount of time required for light to propagate between the first modulation unit and the second modulation unit.

12. The system of claim 1, further comprising a rotation sensor configured to allow the optical circuit to rotate, wherein the processing system is further configured to determine a rotational movement of the optical circuit based on the optical phase difference.

13. The system of claim 12, further comprising a calibration interferometer configured to detect shifts in a frequency of the light of the optical source relative to a frequency of light propagating in the optical circuit, wherein the processing system is further configured to determine the rotational movement based on the optical phase difference and the detected shifts in the frequency of the light of the optical source.

14. The system of claim 13, wherein the calibration interferometer comprises:
an optical coupler configured to receive a first reference signal and a second reference signal, wherein the first reference signal comprises a portion of the light from the optical source, and the second reference signal comprises a portion of the first and second optical beams that have traversed the optical circuit;
a first optical waveguide and a second optical waveguide operatively coupled to the optical coupler such that the first optical waveguide guides the first reference signal and the second optical waveguide guides the second reference signal;
and an optical detector configured to detect the first and second reference signals after the first and second reference signals have traversed the first and second optical waveguides, respectively;
wherein the processing system is further configured to receive from the optical detector of the calibration interferometer a calibration signal, which is indicative of a frequency difference between the first and second reference signals, and to determine shifts in the frequency of the light of the optical source relative to a frequency of light propagating in the optical circuit based on the calibration signal.

15. The system of claim 1, wherein the light from the optical source is frequency-modulated.

16. The system of claim 15, wherein the light from the optical source is frequency-modulated by a frequency corresponding to the inverse of a time required for light to traverse the optical circuit.

17. The system of claim 1, wherein the optical source is a broadband optical source.

18. The system of claim 1, wherein the optical source is a laser.

19. The system of claim 1, wherein the optical circuit further comprises:
a third modulation unit connected in parallel to the first modulation unit and configured to modulate light passing through it with a third modulation code;
a fourth modulation unit connected in parallel to the second modulation unit and configured to modulate light passing through it with a fourth modulation code which is different from the third code; and
polarisation control elements configured to control a polarisation of a portion of the first and second optical beams to a first polarisation state and to control a polarisation of another portion of the first and second beams to a second polarisation state;
wherein the first and second modulation units are configured to modulate the portion of the first and second beams in the first polarisation state;
wherein the third and fourth modulation units are configured to modulate the portion of the first and second beams in the second polarisation state;
wherein the processing system is further configured to determine a polarisation transfer function of the optical circuit by demodulating the interference signal based on the first, second, third, and fourth modulation codes, and to determine the optical phase difference between the first and second beams based on the polarisation transfer function;
wherein a correlation of the third modulation code with a time-shifted version of itself is maximum for a zero time shift; and
wherein a correlation of the fourth modulation code with a time-shifted version of itself is maximum for a zero time shift.

20. The system of claim 19, wherein the polarisation transfer function comprises a Jones matrix for the optical circuit.

21. A method for fibre-optic Sagnac interferometry, the method comprising:
obtaining light from an optical source;
splitting the light from the optical source into a first optical beam and a second optical beam;
performing a first modulation process by modulating the first optical beam with a first modulation code and modulating the second optical beam with a second modulation code which is different from the first modulation code;
after the first modulation process, causing the first and second beams to simultaneously traverse an optical fibre in opposite directions;
after the first and second beams have traversed the optical fibre, performing a second modulation process by modulating the first optical beam with the second modulation code and modulating the second optical beam with the first modulation code;
after the second modulation process, detecting the first and second optical beams with an optical detector to generate an interference signal indicative of an optical phase difference between the first and second optical beams; and
determining the optical phase difference by demodulating the interference signal based on the first and second modulation codes;
wherein a correlation of the first modulation code with a time-shifted version of itself is maximum for a zero time shift; and
wherein a correlation of the second modulation code with a time-shifted version of itself is maximum for a zero time shift.
